(19) United States
(12) Patent Application Publication
(10) Pub. No.: US 2016/0306895 A1
(43) Pub. Date: Oct. 20, 2016

(54) WEB APPLICATION ACCELERATION WITH PERSONALIZED CACHE OR PRERENDERING

(71) Applicant: INTERDIGITAL PATENT HOLDINGS, INC., Wilmington, DE (US)

(72) Inventors: John D. Kaewell, Jamison, PA (US); Shoshana Loeb, Philadelphia, PA (US)

(73) Assignee: INTERDIGITAL PATENT HOLDINGS, INC., Wilmington, DE (US)

(21) Appl. No.: 15/102,237

(22) PCT Filed: Dec. 15, 2014
(86) PCT No.: PCT/US14/70374

§ 371 Date: Jun. 6, 2016

Related U.S. Application Data
(60) Provisional application No. 61/919,800, filed on Dec. 22, 2013.

(51) Int. Cl. G06F 17/30; H04L 29/08

(52) U.S. Cl. CPC G06F 17/30902; H04L 67/02; H04L 67/22; H04W 88/02

(57) ABSTRACT

Systems and methods are provided for predicting user browsing behavior and developing a personalized pre-fetching strategy. In some embodiments, a user equipment entity identifies web pages that are linked from a page being visited by a user, and, based on a user model, determines pre-fetch weights for the linked pages. The user equipment then pre-fetches the web pages with weights above a pre-fetch threshold. In some embodiments, the pre-fetch strategy is generated by or with the assistance of a separate network entity, which may be a distributed logical entity. Policies may also be enforced, such as avoiding pre-fetching while a user is on the telephone, or avoiding pre-fetching of pages containing video.

### CROSS-REFERENCE TO RELATED APPLICATIONS

The present application is a non-provisional filing of, and claims benefit under 35 U.S.C. §119(e) from, U.S. Provisional Patent Application Ser. No. 61/919,800, filed Dec. 22, 2013, incorporated herein by reference in its entirety.

### BACKGROUND

The amount of time it takes to render a Web Application is a critical measure of its performance. As more and more features are added to web applications, it becomes more difficult to achieve short application startup times. Sophisticated web application features are implemented as a combination of HTML, Cascaded Style Sheets, JavaScript code, images, audio, video and other resources.

Often a user will navigate away from a given web application if it loads too slowly. There are three human perceptual time limits which should be considered when loading a web application:

100 ms is roughly the response time needed to give the user the feeling that the system is responding instantaneously.

1,000 ms is about the limit for user to have a mental context switch. The user starts to lose the feeling of directly interacting with the application.

10 s is about the limit to keep the user somewhat focused on the dialog. Users will want to start performing other tasks while waiting for the response. On this time scale, it is helpful for the user to be given an indication of when the application will finish loading.

The most satisfying user experience will be with response times of 100 ms. The response time of 1 second greatly increases the probability that the user will navigate away from the application and move on to something else.

The average web site is over 1.2 MB in size, composed of 88 resources such as JavaScript, HTML and CSS files and delivered from 15 distinct hosts (based on a January, 2013 survey of the top 300,000 web destinations). The average size of a resource requested by a browser is about 12 KB. This means that most of the network transfers to the browser are short and bursty. The underlying transport mechanism for HTTP is TCP, which is optimized for large payloads. The short, bursty nature of most of the browser's traffic increases the potential of web application loading delay due to various TCP operations. It is estimated that over 80% of the delay typically seen by a user in loading an application in a browser is due to network latency.

When the uniform resource locator (URL) of a resource is parsed by a browser, the browser first checks its local caches to see if the resource is cached locally. If so, the browser will load the cached resource if the resource was previously fetched and it has not expired. The use of cached resources will greatly minimize application loading delay.

Mobile browser usage has grown exponentially and is believed to have eclipsed desktop browsing. However, the mobile browser is much more resource constrained than a desktop browser due to the size, power and cost constraints of a mobile handset. For example desktop users navigate with a mouse and can have overlapping windows on a large screen. Desktop users are typically not power constrained; they usually have access to a stable, high-speed network connection and have access to larger amounts of memory and CPU capability. Mobile users rely on touch and gesture based navigation, have a smaller screen, are battery and power constrained, generally have less robust network connections and have limited local memory.

Many applications are based in the web. SaaS (“Software as a Service”) and IaaS (“Infrastructure as a Service”) are cost effective and productive service models for delivery of applications to users. These services are becoming more popular and mainstream for many individuals and enterprises.

### SUMMARY

Described herein are systems and methods for enabling the acceleration of web browser application loading through personalized cache utilization. In one embodiment, the system comprises a Personalized Cache/Prerendering Manager (PCPM). The PCPM may be a distributed logical entity that enables the personalized and optimized accelerated and efficient web browser application loading through specialized mechanisms for cache utilization that rely on user modeling and other specific information that allow for targeted and effective information management. The PCPM can reside physically at the mobile device, at the edge of the cloud, and/or in the cloud. When the PCPM is implemented on physically separate computing devices, the separate communications devices can communicate with one another using a standardized communication protocol such as TCP or UDP sockets.

The Personalized Cache/Prerendering Manager (PCPM) may be engaged when a user is utilizing a computer system to browse the web through a web browser. At any point in time there is a visible page that the user can potentially interact with the page by clicking on objects (e.g., links) on the page that will cause new information to be displayed on that same page or on a newly displayed page.

### BRIEF DESCRIPTION OF THE DRAWINGS

A more detailed understanding may be had from the following description, presented by way of example in conjunction with the accompanying drawings.

FIG. 1A depicts an example communications system in which one or more disclosed embodiments may be implemented.

FIG. 1B depicts an example wireless transmit/receive unit (WTRU) that may be used within the communications system of FIG. 1A.

FIG. 1C depicts an example radio access network (RAN) and an example core network that may be used within the communications system of FIG. 1A.

FIG. 1D depicts a second example RAN and a second example core network that may be used within the communications system of FIG. 1A.

FIG. 1E depicts a third example RAN and a third example core network that may be used within the communications system of FIG. 1A.

FIG. 1F depicts an example network entity that may be used within the communication system of FIG. 1A.

FIG. 2 depicts a Personalized Cache/Prerendering Manager according to some embodiments.

FIG. 3 depicts a software architecture of modules associated with some embodiments.

FIG. 4 depicts inputs and outputs of a predictive user model contractor module according to some embodiments.

FIG. 5 depicts an exemplary method performed by a user equipment entity in accordance with an embodiment.

FIG. 6 depicts an exemplary method performed by a network entity in accordance with an embodiment.

FIG. 7 illustrates a user interface for comparing the expected quality of experience of different caching strategies.

### DETAILED DESCRIPTION

A detailed description of illustrative embodiments will now be provided with reference to the various Figures. Although this description provides detailed examples of possible implementations, it should be noted that the provided details are intended to be by way of example and in no way limit the scope of the application.

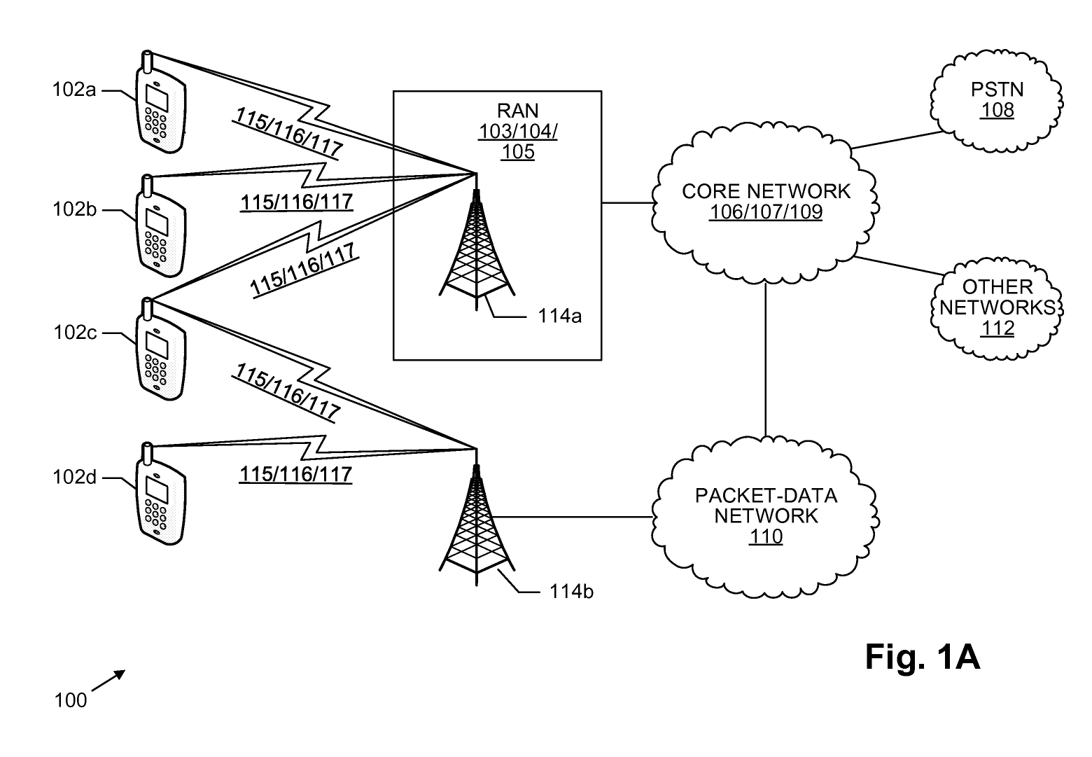

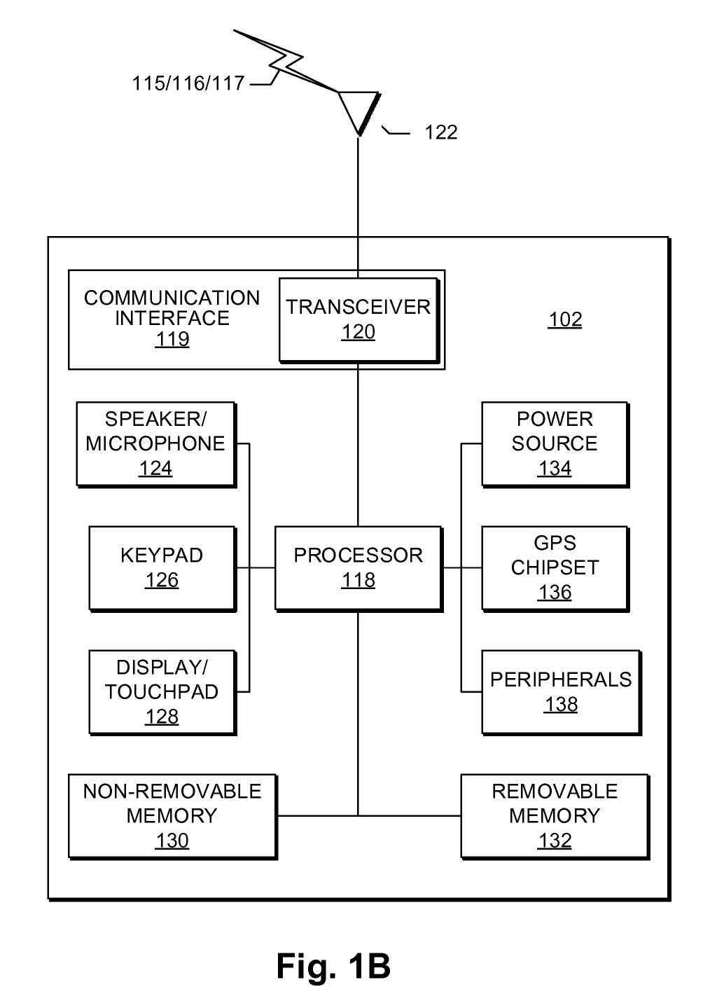

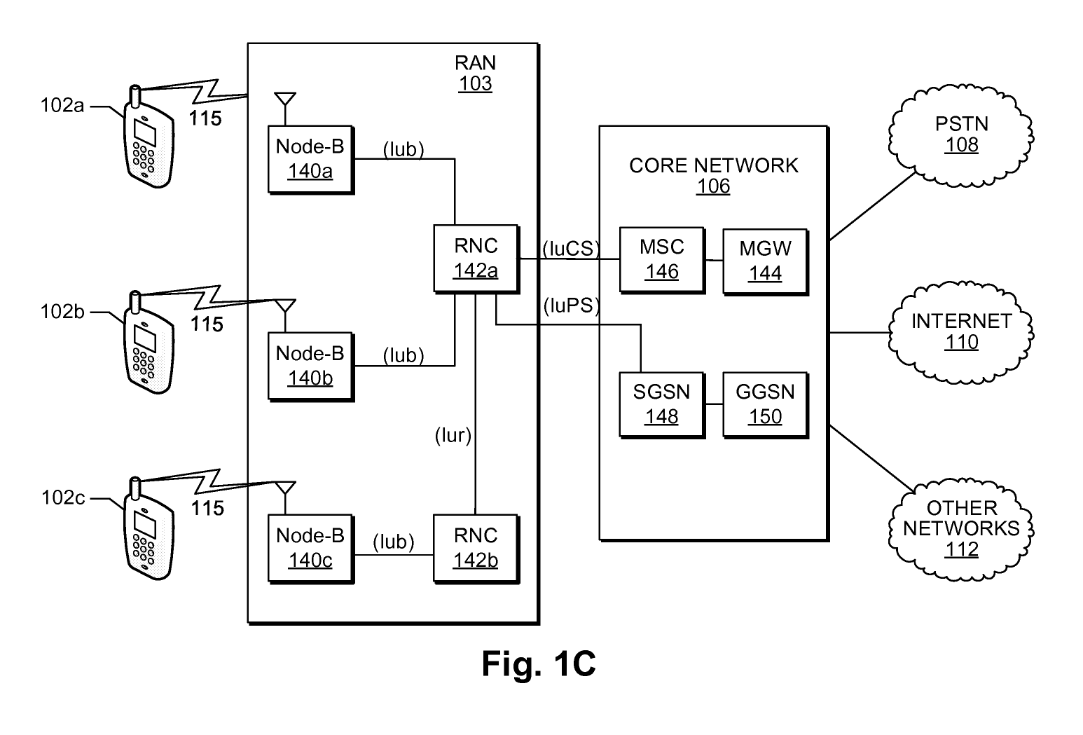

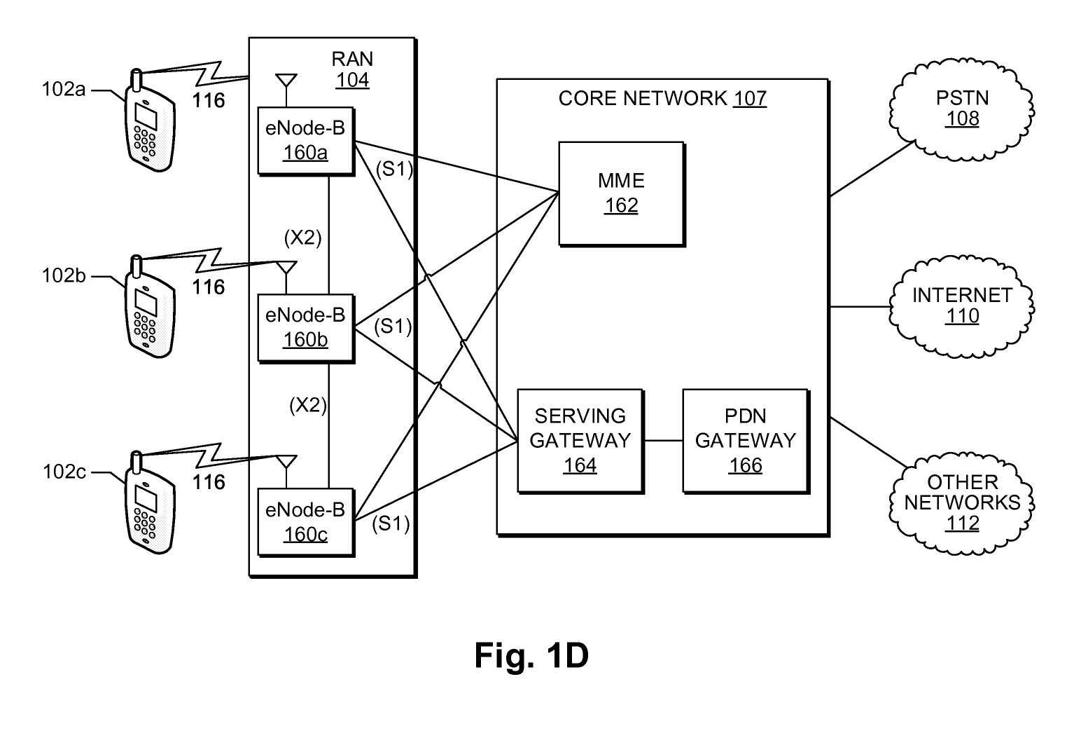

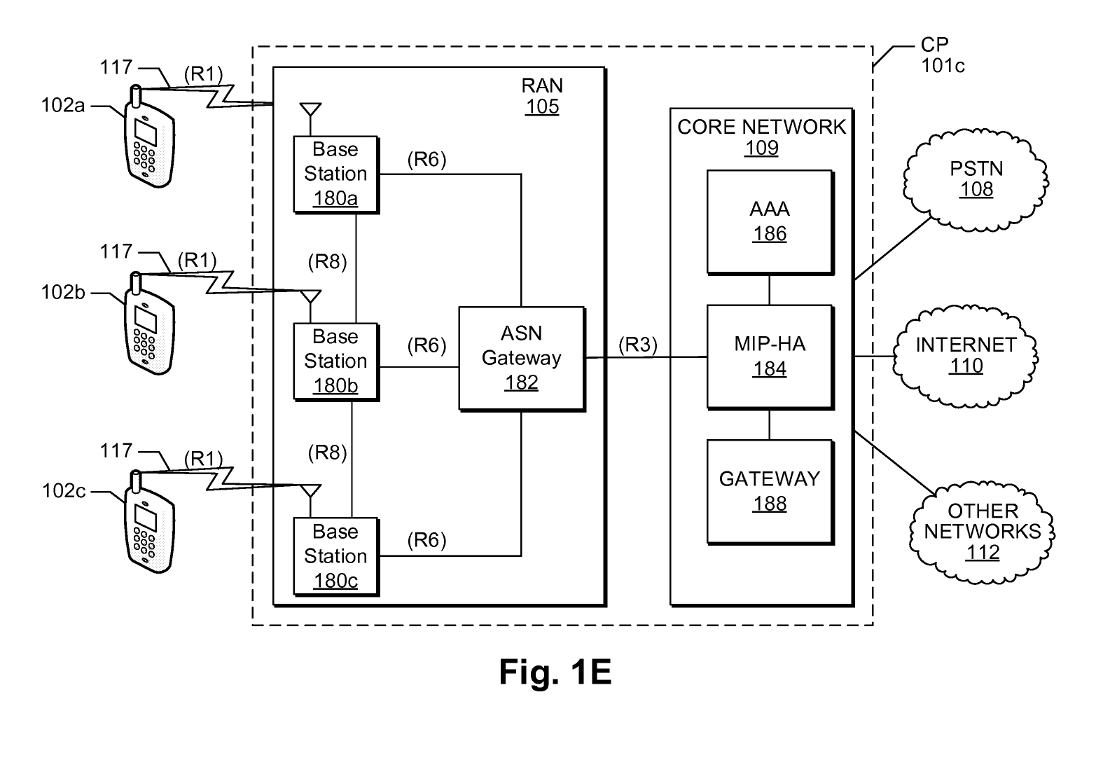

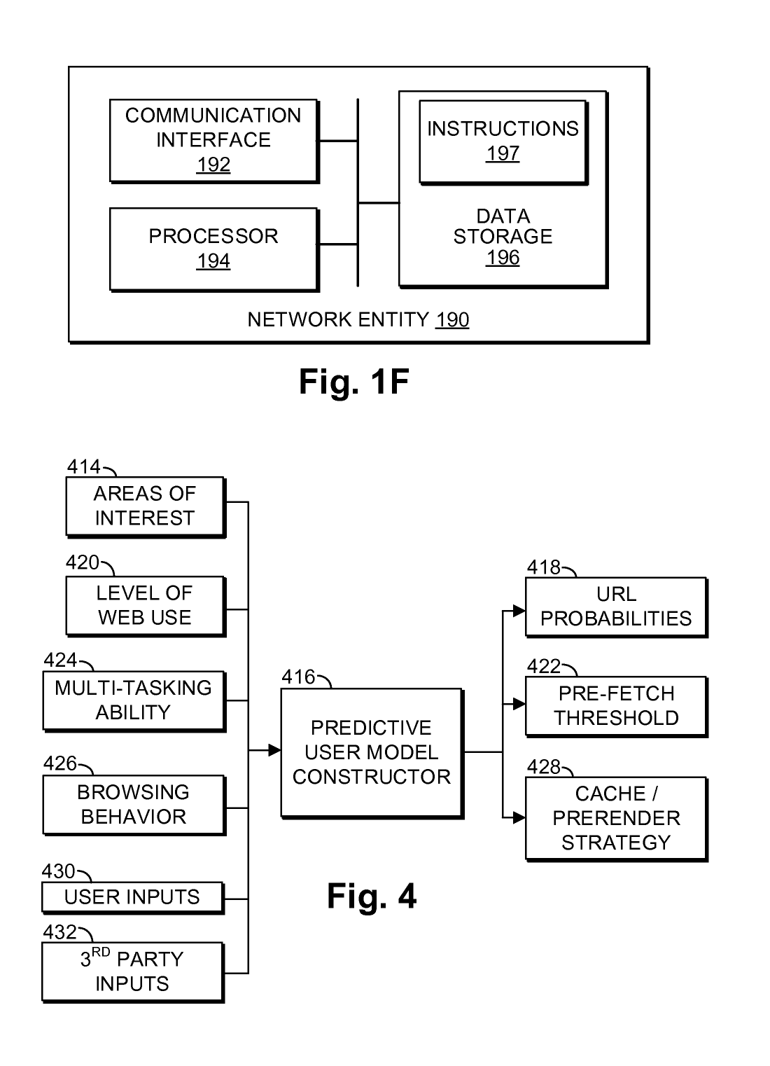

FIG. 1A is a diagram of an example communications system 100 in which one or more disclosed embodiments may be implemented. The communications system 100 may be a multiple access system that provides content, such as voice, data, video, messaging, broadcast, and the like, to multiple wireless users. The communications system 100 may enable multiple wireless users to access such content through the sharing of system resources, including wireless bandwidth. For example, the communications systems 100 may employ one or more channel-access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include WTRUs 102a, 102b, 102c, and/or 102d (which generally or collectively may be referred to as WTRU 102), a RAN 103/104/105, a core network 106/107/109, a public switched telephone network (PSTN) 108, a packet data network 110, such as the Internet, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, and the like). The air interface 115/116/117 may be established using any suitable radio access technology (RAT).

More specifically, as noted above, the communications system 100 may be a multiple access system and may employ one or more channel-access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, as examples, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, and the like) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. As examples, the core network 106/107/109 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and IP in the TCP/IP Internet protocol suite. The networks 112 may include wired and/or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a communication interface 119 including a transceiver 120, a transmit/receive element 122, a speaker/microphone 124, a keypad 126, a display/touchpad 128, a non-removable memory 130, a removable memory 132, a power source 134, a global positioning system (GPS) chipset 136, and sensors 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, as examples. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, as examples.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. As examples, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include sensors such as an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer-loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional landline communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between the WTRUs 102a, 102b, 102c and IP-enabled devices.

As noted above, the core network 106 may also be connected to the networks 112, which may include other wired and/or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio-resource-management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management entity (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode-B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional landline communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired and/or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility-management functions, such as handoff triggering, tunnel establishment, radio-resource management, traffic classification, quality-of-service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point (not shown), which may be used for authentication, authorization, IP-host-configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility-management capabilities, as examples. The core network 109 may include a mobile-IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA 184 may be responsible for IP-address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional landline communications devices. In addition, the gateway 188 may provide the WTRUs 102a, 102b, 102c with access to the networks 112, which may include other wired and/or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point (not shown), which may include protocols for coordinating the mobility of the WTRUs 102a, 102b, 102c between the RAN 105 and the other ASNs. The communication link between the core network 109 and the other core networks may be defined as an R5 reference point (not shown), which may include protocols for facilitating interworking between home core networks and visited core networks.

FIG. 1F depicts an example network entity 190 that may be used within the communication system 100 of FIG. 1A. As depicted in FIG. 1F, network entity 190 includes a communication interface 192, a processor 194, and non-transitory data storage 196, all of which are communicatively linked by a bus, network, or other communication path 198.

Communication interface 192 may include one or more wired communication interfaces and/or one or more wireless-communication interfaces. With respect to wired communication, communication interface 192 may include one or more interfaces such as Ethernet interfaces, as an example. With respect to wireless communication, communication interface 192 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 192 may be equipped at a scale and with a configuration appropriate for acting on the network side—as opposed to the client side—of wireless communications (e.g., LTE communications, Wi-Fi communications, and the like). Thus, communication interface 192 may include the appropriate equipment and circuitry (perhaps including multiple transceivers) for serving multiple mobile stations, UEs, or other access terminals in a coverage area.

Processor 194 may include one or more processors of any type deemed suitable by those of skill in the relevant art, some examples including a general-purpose microprocessor and a dedicated DSP.

Data storage 196 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 1F, data storage 196 contains program instructions 197 executable by processor 194 for carrying out various combinations of the various network-entity functions described herein.

In some embodiments, the network-entity functions described herein are carried out by a network entity having a structure similar to that of network entity 190 of FIG. 1F. In some embodiments, one or more of such functions are carried out by a set of multiple network entities in combination, where each network entity has a structure similar to that of network entity 190 of FIG. 1F. In various different embodiments, network entity 190 is—or at least includes—one or more of (one or more entities in) RAN 103, (one or more entities in) RAN 104, (one or more entities in) RAN 105, (one or more entities in) core network 106, (one or more entities in) core network 107, (one or more entities in) core network 109, base station 114a, base station 114b, Node-B 140a, Node-B 140b, Node-B 140c, RNC 142a, RNC 142b, MGW 144, MSC 146, SGSN 148, GGSN 150, eNode-B 160a, eNode-B 160b, eNode-B 160c, MME 162, serving gateway 164, PDN gateway 166, base station 180a, base station 180b, base station 180c, ASN gateway 182, MIP-HA 184, AAA 186, and gateway 188. And certainly other network entities and/or combinations of network entities could be used in various embodiments for carrying out the network-entity functions described herein, as the foregoing list is provided by way of example and not by way of limitation.

Described herein are systems and methods that may be used with the systems described with respect to FIGS. 1A-1F for enabling the acceleration of web browser application loading through personalized cache utilization. In one embodiment, the system comprises a Personalized Cache/Prerendering Manager (PCPM). The PCPM is a distributed logical entity that enables the personalized and optimized accelerated and efficient web browser application loading through specialized mechanisms for cache utilization that rely on user modeling and other specific information that allow for targeted and effective information management. It can reside physically at the mobile device and/or at the edge of the cloud or in the cloud. In one embodiment a standardized communication protocol between the logical but physically separated entity is used such as TCP or UDP sockets.

The system, in one embodiment, includes automatic construction of an actionable user model. This may include the automatic learning of user behaviors and preferences for the purpose of optimizing browser cache utilization, e.g. predicting future resource downloads.

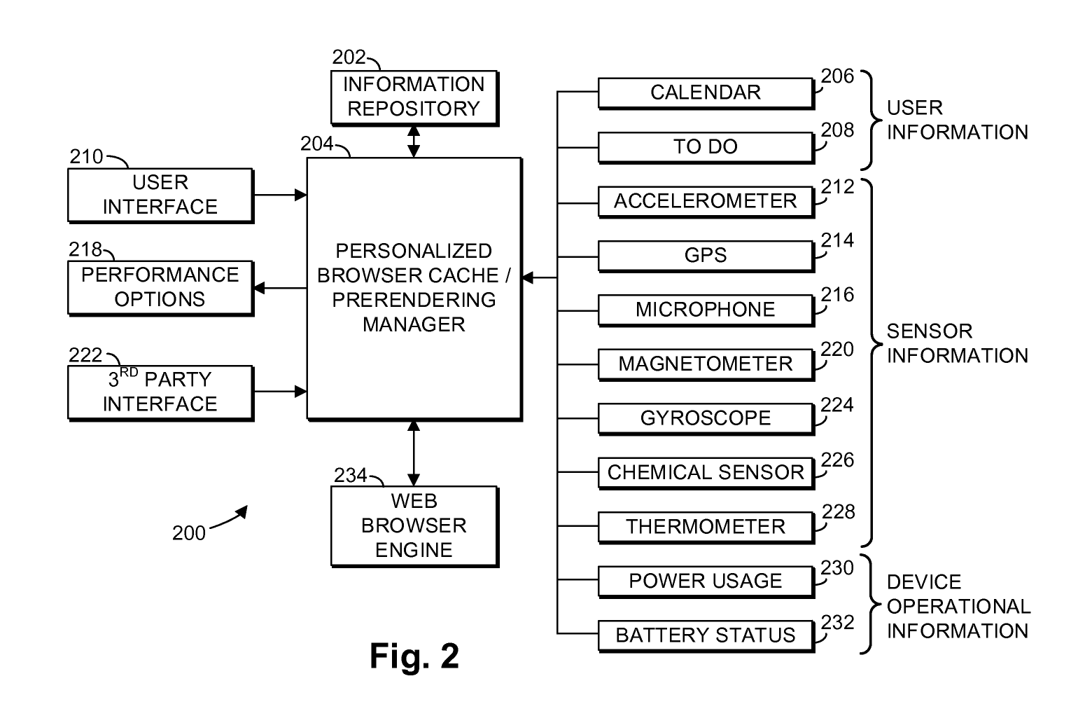

The system 200 shown in FIG. 2 is one embodiment, and includes a personalized browser cache/prerendering manager PCPM 204 in communication with a web browser engine 234. It also depicts an information repository 202, a user interface 210, performance option output parameters 218, a third party interface 222 for receiving third party input parameters, information sources such as calendar data 206, to-do list data 208, as well as sensors that may be used to detect multitasking such as speaking on the phone, walking, running, cooking, physical wellbeing, and the like. Sensors may include an accelerometer 212, a GPS receiver 214, microphone 216, magnetometer 220, gyroscope 224, chemical sensor 226, temperature sensor 228, as well as device operational data such as power usage meter (or metric generator) 230 and battery status device/indicator 232. The user-specific data sources such as calendars and to-do-lists can be used to determine the user intentions and activities.

The Personalized Cache/Prerendering Manager (PCPM) may be engaged when a user is utilizing a computer system to browse the web through a web browser. At any point in time there is a visible page that the user can potentially interact with the page by clicking on objects (e.g., links) on the page that will cause new information to be displayed on that same page or on a newly displayed page.

One example caching strategy is described as follows: at any given time when the user is browsing page A and that page A contains L links for other pages, the PCPM will be using an algorithm to determine at which priority to pre-fetch and/or prerender these L pages to the browser, in anticipation of the user wanting to view them.

The PCPM software system enables real time control of web browser caching strategy and its execution. This system may replace, augment or over-ride the default caching strategy of the browser. The PCPM system can be co-located on the same connected device as the browser (e.g., laptop, tablet, mobile device), or it can operate on behalf of the user while residing at the edge cloud or the cloud. Furthermore, in some embodiments, the PCPM system is distributed among the above locations in such a way that the computation load is divided between these cooperating instances. In this case, a standardized communication protocol between the logical but physically separated entity could be used, such as TCP or UDP sockets. In such an embodiment, the user device may communicate metadata to the PCPM about the current browsing session, such as a URL that is being viewed. The network-based PCPM device may then independently retrieve the data at that URL and independently analyze the content and formulate a caching strategy that is then conveyed to the user equipment (UE) such as a WTRU. Other data transmitted to the network-based entity other inputs such as UE sensor data as described above.

As will be appreciated by one skilled in the art, aspects of the present disclosure and of computer system 190 may be embodied as an apparatus that incorporates some software components. Accordingly, some embodiments of the present disclosure, or portions thereof, may combine one or more hardware components such as microprocessors, microcontrollers, or digital sequential logic, etc., such as processor 194 with one or more software components (e.g., program code, firmware, resident software, micro-code, etc.) stored in a tangible computer-readable memory device such as memory 196, that in combination form a specifically configured apparatus that performs the functions as described herein. These combinations that form specially-programmed devices may be generally referred to herein “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, and the like. A given module may even be implemented such that the described functions are performed by separate processors and/or computing hardware platforms.

In one embodiment, the PCPM system comprises various modules. User model modules automatically construct and update user models based on stored and streaming data sources. Inference modules operate to determine the optimal real-time caching strategy. Input modules allow the user to input and modify the user model and may allow third parties (including network carriers) to input and modify the user model. In some embodiments, the UE may be configured to fetch caching parameters from a carrier's network. In other embodiments, the UE may be configured to receive push notifications from the carrier or other third party service provider. Caching parameters may be set based on a service-level agreement, and may also be based on network capacity or resource constraints. In further embodiments, feedback modules are included that may be configured to display to the user the resource consumption and usability parameters that are entailed in the current caching strategy as well as hints on how to impact them. This includes power consumption, data usage, pricing, and other parameter impacts.

The PCPM may utilize information repositories and streaming information sources including one or more of: (i) a user model; (ii) the current state of the browser (e.g., which page is the user viewing and for how long, gaze and other usage information (to the extent such information is available in a given embodiment)); (iii) recent browsing history; and, (iv) current user context and other activities and in particular multi-tasking (e.g., editing a document, speaking on the phone).

As shown in FIG. 2, the PCPM uses a specialized user model to determine with the aid of additional context and user activities information at any given time interval what would be the most optimal caching strategy for the web browser. This determination can take place when specific conditions are met. This includes but is not limited to: (i) at a specific time of day; (ii) at specific time intervals; (iii) for each new page that is displayed to the user; (iv) when major changes happen to the access network; (v) when major changes happen to the user behavior.

The specific trigger for activation the strategy determination can be set automatically by the user or by others or can be computed using patterns of user behavior.

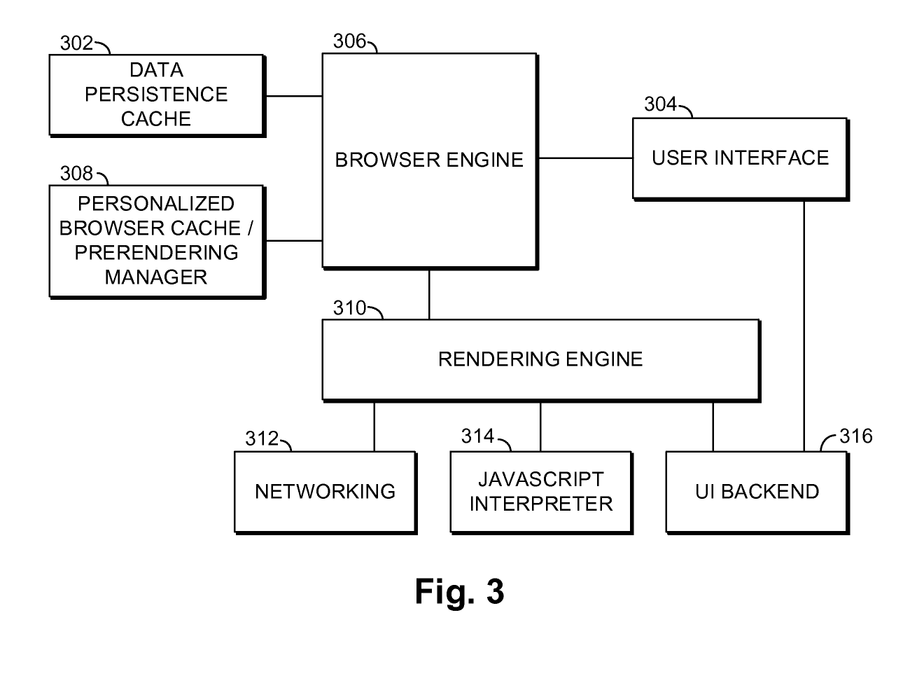

With reference to FIG. 3, the Personalized Cache/Prerendering Manager may be integrated into a modern browser's main components. System 300 includes a data persistence cache module 302, user interface module 304, browser engine module 306, networking module 312, JavaScript interpreter module 314, UI backend module 316 and PCPM module 308.

In some embodiments, the PCPM operates in real time as the user is browsing a specific page A. The PCPM obtains a list of URLs of links that appear on the page and assigns each potential linked page a unique identifier (which may be the URL of the linked page or other identifier). Obtaining the list of URLs of links in a page can be done by intercepting native page loading events such as the PageFinishedLoading Event in the Chrome Browser and then parsing all hyperlinks in the page.

The PCPM generates a caching strategy that takes the form of a prioritized list of probabilities and a threshold parameter, a policy, or a combination of the two. The list of probabilities can take the following form:

Page 1 id Probability 1

Page 2 id Probability 2

. . .

Page L id Probability L

The threshold parameter will determine which pages of the priorities list will be pre-fetched. The value of the threshold parameter will be determined by the PCPM using various contextual parameters including user current activity and network loads. In some embodiments, the threshold may be based on a cost function associated with the pages. In one such embodiment, the cost function may be formed from a combination of a probability and an amount of data associated with the corresponding page. The threshold may also be subject to configuration by a user

As examples of strategies in a form of policies, one policy can indicate that a page containing video should not be pre-fetched. Policies can also be implemented stochastically. For example, a policy can indicate that pages containing video should be pre-fetched 80% of the time on weekends but only 60% of the time on weekdays. Another policy might indicate that if the user is performing another task (e.g, talking on the phone, checking email, watching a movie), no page should be pre-fetched.

In some embodiments the policy makes a real time determination of the probability of pre-fetching a given page and also modifies the ranking of a given priority list given changing context and other real-time parameters. When information such as user information or third party input changes, the PCPM may operate to develop a new pre-fetch strategy, for example by generating a new set of probabilities and/or a new threshold. The history of the user's browsing behavior may also be used in the generation of probabilities. For example, the user's browsing history may indicate that he is more likely to watch video over the weekend compared to during the week.

Construction and use of a predictive user model is illustrated schematically with respect to FIG. 4. In some embodiments, the user model is constructed and modified in real time or at specific intervals in a variety of ways. One example uses automatic statistical machine learning techniques as well as symbolic reasoning (AI) techniques. Those skilled in the art will be familiar with the various available prioritization, recommendation and user behavior prediction algorithms and methods which can be useful to build the actionable user model. The predictive user model 416 may operate to generate information such as the probabilities 418 that a user will navigate to particular URLs, or it may assign other pre-fetch weights to different URLs. For example, a pre-fetch weight may be a value that increases based on a probability that the user will navigate to the URL and that decreases with increased size of a web page at the particular URL. The pre-fetch threshold may be increased or decreased in response to other information regarding the user and the network state as discussed below.

The predictive user model 416 can take various information as an input. For example, the user's areas of interest 414 may be received, and the predictive user model 416 can determine that a user is more likely to navigate to a web page in accordance with his interests. The user's level of web use, e.g. how often the user is engaged in intensive of browsing, can also be taken into consideration. For example, users who tend to browse the web more intensively can be accommodated with more aggressive pre-fetching (e.g., a lower pre-fetch threshold, or higher pre-fetch weights).

In some embodiments, a user model includes a list of user preferences, including a list of topics in which the user is interested (e.g., basketball, vegan food, men's fashion) or a list of attribute-value pairs where the topics (attributes) are paired with a numeric weight signifying their level of importance (e.g., basketball 1.0, vegan food 0.8, men's fashion 0.2). The weights could be calibrated to add up to 1.0, for example. In such embodiments, the user's preferences can be matched against a list of attributes of the different links. The list of link attributes (e.g., page meta-data) can be obtained in a variety of ways, such as by parsing the link name or parsing the link tags. If a match is found, then the link is added to the prefetch list. When the matching process is complete the prefetch list is sent (e.g., via inter process communication) to the browser for rendering. The rendering can be performed by over-riding the native or default prefetching policy of the browser.

Information 424 regarding a user's ability or interest in multitasking (which may be self-reported or inferred from user behavior) can be taken into consideration by the predictive user model 416. For example, when a user is unskilled at multitasking, and when that user is engaged in another activity, such as streaming media, talking on the telephone, or engaged in physical activity such as exercise, the pre-fetch threshold may be raised substantially, or pre-fetching may be halted altogether. On the other hand, when a user is skilled at multitasking, the user's engagement in another activity may have less of an effect or no effect on the pre-fetch threshold. Other temporal browsing behavior information 426, such as information indicating the time of day when the user browses most intensively, may also be taken into consideration. Various user inputs 430, such as user preferences regarding levels of pre-fetching or cache sizes, can also be taken into consideration. Information 432 from third parties, e.g. information from an access provider regarding a level of network congestion, can also be taken into consideration. For example, a pre-fetch threshold can be raised to prevent excessive pre-fetch traffic under conditions of network congestion.

Using the information it receives, the predictive user model 416 generates a cache/pre-rendering strategy 428, which may include a list of URLs or other identifiers for web pages, along with a pre-fetch weight for each of the identifiers.

In situations where link attributes do not correspond to any of the attributes in the user model, the caching policy may automatically assign a probability of 0% to the relevant link. In some embodiments, the system may occasionally (randomly or with some regularity) pre-fetch such pages to support serendipitous downloads.

User input to the user model is provided by an input module. This module offers the user the ability to input and update his or her model by specifying general preferences, e.g. by indicating that when he or she browses the web using a smart phone, video should not be pre-fetched unless explicitly requested. The module may display the impact and tradeoffs of the caching strategy on device resources and user experience: it may give the user the option to view and modify the impact of the cache strategy on power utilization (battery life), latency, bandwidth and other resources. In one embodiment, the user is provided a graphical slider input such that caching activity may be increased to improve browsing responsiveness during user-defined periods of intensive activity.

User input capability can be offered through various modalities. For example, a user may interact with the system through a website with a “settings” web page that can be accessible either as an option on the browser menu or as an independent website/portal that the user can access through typing the associated URL. On the settings page, a list of links is provided directing a user to various settable parameters. One of the links directs the user to a user model page. Once on this page, a list of attribute value pairs is displayed that signify his preferences as mentioned above. Another link in the setting page directs the user to a page in which he can set the caching probability threshold based on various parameters such as time of day, day of week and special holiday and events as well as the device being used (e.g., laptop vs. mobile device). A third link on the setting page can take the user to a page where he can see the impact and tradeoffs of the various caching strategies and other parameters on resources utilization and quality of experience (“QoE”). These links can lead to separate pages or can reside on the setting page and can open a menu when selected. Other visual method of display can be used as well. In some embodiments, the settings page is voice activated.

Those skilled in the art will be familiar with the various available prioritization, recommendation and user behavior prediction algorithms and methods that can be useful to build the actionable user model. For example, user behavior can be predicted based on a Markov model of the user's past browsing behavior either on its own or in combination with the browsing behavior of other users.

Third-party input to the user model or caching strategy may also be provided. From time to time a third party, such as a network carrier or an application provider (e.g., a game provider) can be allowed to modify the user model or the caching strategy. This includes input from network carriers when they need to better optimize the last-mile performance (e.g., eliminate excessive caching when the last mile is congested). The user may be allowed to opt-in to enable third-party inputs to the model and to the caching strategy. In some embodiments, the user may be rewarded for opting in by receiving more cost effective service and higher quality.

The impact and tradeoffs of caching strategy on device resource and user experience may be displayed. To enable the user to understand the cost/benefit tradeoffs of the various caching strategies, the PCPM may be configured with a module or subsystem to determine for any given user model and caching strategy what is the resulting effect. The caching strategy impact can be quantified in a variety of ways that include but are not limited to: (i) Power consumption; (ii) User experience (e.g., latency of download of a new page); (iii) Bandwidth utilization/cost. This module will present the information in a visual display and will also allow the user access to modifying the caching strategy and seeing the effect of the change.

The subsystem for predicting the effect of different caching strategies consists of various computational modules including a historical database that contains information about resources consumption by the browser in the past for the various caching strategies that were employed. These resources will be specific to a device that the user is using.

For example, the predictive subsystem may contain information about the typical distribution of links attribute in pages of the various known websites that the user frequents, so when the user model specifies that only a small percentage of these attributes will be of interest to the user, this will then correspond to a savings in both battery and bandwidth which is quantifiable. For example, if the user model specifies that the number of attributes that are above the threshold for a typical web page constitutes only 5% of the attributes on links of typical webpages that the user usually browses (based on the user's history), then the savings of battery and bandwidth will be a function of the 95% of the links that will not be pre-fetched. This can be displayed to the user in a form of a bar that shows 95% in one color and 5% in another, or in a form of a histogram or pie chart or any other form of visual display of numeric information. Analogous techniques can be used to compute the effect of different caching strategies on the bandwidth. The user is permitted to change the threshold and observe the impact of the new threshold on the savings described above. This can be shown side by side with the old computation or in any other way.

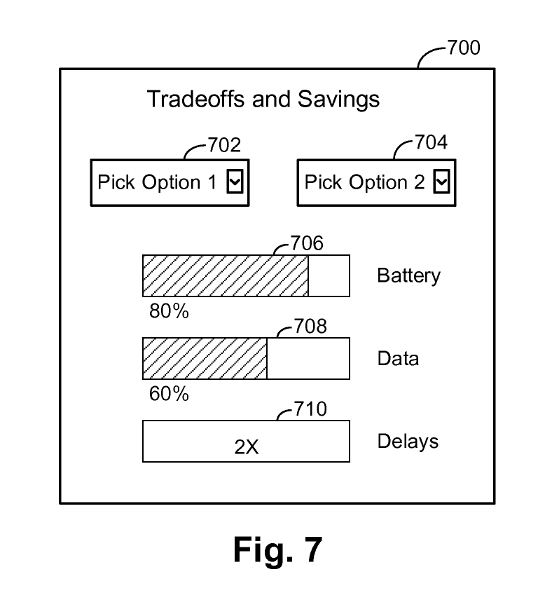

An exemplary user interface is illustrated in FIG. 7. A prediction page 700 displays the “Tradeoffs and Savings” available with the use of different options. Pull-down menus 702 and 704 direct users to settings pages from which the user can set preferences such as attribute-value pairs and caching probability thresholds. The prediction page 700 displays the relative advantages and disadvantages of the different settings based on the predictions of the prediction subsystem. Using the statistical information discussed above, these two models are compared in terms of resource utilization and predicted QoE, and the information is presented to the user. For example, the prediction page 700 may indicate using graphics 706, 708, and 710 that the options set under Option 1 lead to an 80% savings in battery use and 60% savings in data use compared to Option 2, but that delays are twice as long. The options under pull-down menus 702 and 704 may include pre-defined options based on historic behavior of the user or of a segment of the population.

The predictive subsystem can also operate to determine expected effects of different caching strategies on the user's quality of experience. The predictive subsystem determines the penalty for not pre-fetching a page that the user ends up being interested in. This penalty can be computed using historical information about delays to fetch a page that was not pre-fetched. Such delays can be recorded on a device and network specific basis, as delays are likely to be different between a laptop on wi-fi vs. mobile device on LTE, for example. The results can be displayed in the form of a table that shows the average expected delays that are likely to occur as a function of the savings in battery and bandwidth. Information in the table may be displayed in the form of, for example, a statement saying “you will be saving 95% on battery life but are likely to encounter 10 seconds delay if we did not pre-fetch a link that you click on.” This information can also be presented graphically.

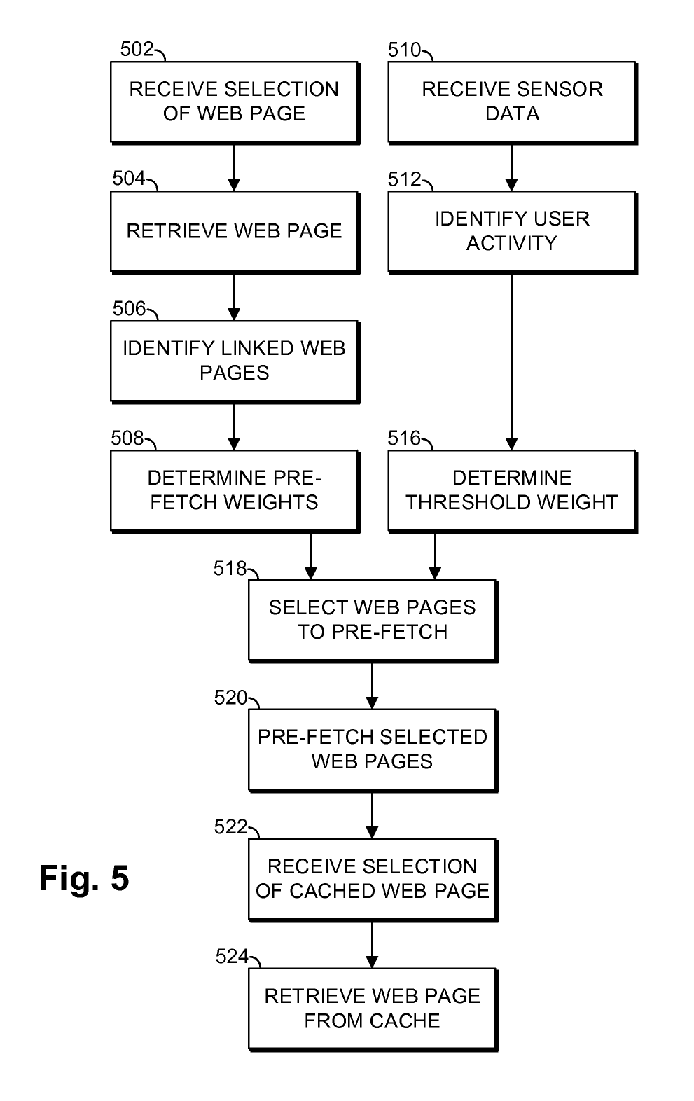

A method carried out by a user equipment entity, such as a WTRU equipped with browser software, is illustrated in FIG. 5. In step 502, the WTRU receives a selection of a web page that a user wishes to visit. This selection may be made by, for example, the user typing in a URL of the web page, the user selecting a link to the web page, the user selecting a shortcut to the web page, or by other means. In response to the user's selection of the web page, the WTRU retrieves the web page using, for example, an HTTP GET request for the web page and for resources in the web page. The visited web page may be rendered and displayed using the browser of the WTRU.

In step 506, the WTRU identifies web pages that are linked from the visited web page. These may be, for example, web pages with a URL provided as a value of the “href” attribute within an “A” (anchor) element in an HTML document. However, as will be apparent to those skilled in the art, other techniques may be used to identify web pages that are linked from the visited web page.

In step 510, the user equipment entity (e.g. the WTRU) receives sensor data and uses that data in step 512 to identify a user activity. For example, the sensor may be an accelerometer, and the WTRU can use a pattern of accelerations from the accelerometer to determine that the user is engaged in physical activity, such as jogging, running, or other exercise. The sensor may be, for example, a GPS receiver, and the user activity can be determined based at least in part on a location or movement of the user. The sensor may be, for example, a thermometer, and the user activity can be determined to be an outdoor activity if the thermometer detects a temperature range outside usual indoor temperatures (e.g, outside a range of 20-26° C. (68-80° F.). In some embodiments, the WTRU includes telephone functionality, and identifying the user activity includes determining whether the user is talking on the telephone. In some embodiments, the WTRU may identify the user activity using inferential statistical techniques (e.g. Bayesian statistics) to identify a most probable user activity using input from a number of different sensors.

Based at least in part on the identified user activity, the WTRU in step 518 selects a number of the linked web pages to pre-fetch. In some embodiments, the selection of web pages to pre-fetch is performed by determining a pre-fetch weight (step 508) for each of the linked web pages and by determining a threshold weight (step 516), where web pages with a pre-fetch weight above the threshold weight are selected to be pre-fetched.

The determination of a pre-fetch weight can be performed using various techniques. For example, employing a user model as described above, the WTRU can determine a probability, for each of the linked web pages, that the user will navigate to the respective web page. Increasing probabilities of navigating to a web page correspond to increasing pre-fetch weights. As noted above, the user model may take into consideration the user's interests and the user's expected activities as determined from, for example, a calendar of the user. For example, a business-oriented web page may be given a relatively greater pre-fetch weight during business hours, while a recreational web page may be given a relatively greater pre-fetch weight after business hours.

In some embodiments, the pre-fetch weight of a linked web page may be based at least in part on a size of the linked web page, including the size of embedded resources in the web page. The pre-fetch weight may decrease for increasing web page size. For example, the pre-fetch weight of a page may be proportional to the probability of navigating to the page divided by the size of the page. The size of the linked web page may be determined in various ways without actually requiring the WTRU to fetch the web page itself to measure the size (which would make irrelevant the question of whether to pre-fetch the page). For example, the size may be an estimated value that is stored locally. In this regard, it can be noted that the front page of a news web site may change frequently in content, but the overall size of the page is likely to remain much more constant. In some embodiments, the size of the linked web page may be determined by a networked server separate from the WTRU. In that way, the networked server can assist the WTRU in determining an effective caching strategy without increasing wireless bandwidth.

In some embodiments, the determination of a threshold weight is based at least in part on the user activity identified in step 512. In some embodiments, each user activity is associated with a predetermined threshold weight. The threshold weight may be assigned based on a likelihood that a user engaged in a particular activity will benefit from high levels of pre-fetching. For example, a user who is identified to be engaged in physical activity, involved in an outdoor activity, watching a video, or talking on the telephone is less likely to demand rapid rendering of web pages and is thus less likely to benefit from a high level of pre-fetching.

As an alternative to the threshold weight being dependent on a user activity, or in addition to such a system, the individual pre-fetch weights of the linked web sites may be determined in part based on the identified user activity. The effect of the identified user activity may be applied to all pre-fetch weights. For example, if a user's browsing activity is reduced by half when the user is engaged in outdoor activity, then all pre-fetch weights may be multiplied by a factor of 0.5 when the user is engaged in outdoor activity. In some embodiments, the effect of the identified user activity may be applied to individual pre-fetch weights. For example, when the user is determined to be traveling (e.g., based on GPS measurements), the pre-fetch weights of web sites relating to hotels and restaurants may be relatively increased.

In some embodiments, the threshold weight is determined based at least in part on a level of network traffic. This traffic level may be reported to the WTRU by a network connectivity provider. In some embodiments, the threshold weight is increased in response to increasing levels of network traffic to prevent excessive amounts of pre-fetching from further burdening the network. Conversely, the pre-fetch threshold may be lowered when there is little network traffic.

In some embodiments, the WTRU determines the pre-fetch weights by retrieving these weights from a networked server. As described in greater detail above, a networked server can provide information including, for example, a list of URLs along with a probability or other type of pre-fetch weight associated with the respective URLs.

In step 520, the WTRU retrieves the web pages that were selected for pre-fetching. For example, the WTRU may retrieve those web pages with pre-fetch weights above a threshold weight. The WTRU may retrieve those web pages in order of decreasing pre-fetch weight, or in a different order. The pre-fetching of the selected web pages includes pre-fetching some or all of the embedded resources (such as images) in the web page. The pre-fetched web pages are stored in a cache, which may be implemented in a memory of the WTRU itself or on a caching server. If the user does in fact select one of the cached web pages (e.g., by selecting the relevant link), as illustrated in step 522, the WTRU retrieves the web page from the cache in step 524. The selected cached page is then rendered and displayed to the user. In some embodiments, particularly where sufficient processing power is available, cached web pages may be rendered in memory before those pages are selected by the user, so that the page appears nearly instantaneously if and when it is selected by the user.

The determination of whether or when to pre-fetch pages can be implemented using policy-oriented rules. For example, a policy may indicate that pre-fetching is not to be performed when the user is engaged in a telephone call on the WTRU. In such a system, as part of identifying the user activity, the WTRU determines whether the user is participating in a telephone call. The pre-fetching may be performed only after a determination is made that the user is not participating in a telephone call. Similarly, a policy may indicate that pre-fetching should not be performed when the user is engaged in physical activity. In such an embodiment, the pre-fetching is performed only after determining that the user is not engaged in physical activity.

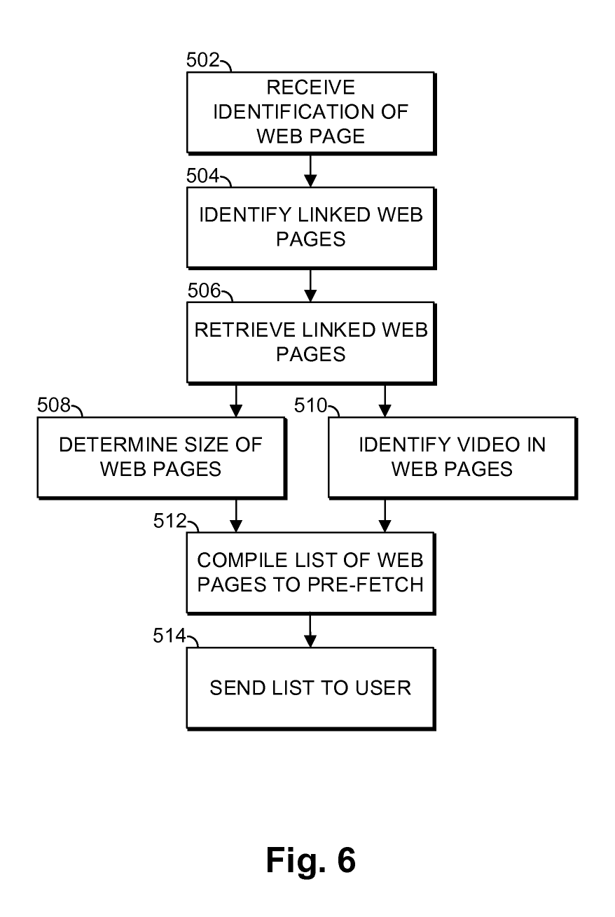

Some embodiments are implemented on network entities (such as network entity 190) that are not necessarily user equipment entities. For example, the embodiment of FIG. 6 illustrates the use of a network entity to improve the browsing experience of a user who is browsing using a separate user equipment entity. The user equipment entity reports to the network entity on the browsing activity of the user. In step 602, the network entity receives, from the user equipment entity, information identifying a web page visited by a user. This information may take the form of, for example, a URL identifying the visited web page.

In step 604, the network entity identifies web pages that are linked from the visited web page. The network entity may perform this by, for example, issuing its own HTTP GET request to the URL visited by the user and parsing the result to identify the linked pages. In step 606, the network entity retrieves at least some of the linked pages to determine the content of the linked web pages. The network entity then prepares as pre-caching strategy for the user based at least in part on the content of the retrieved web pages. The pre-caching strategy may include a list of web pages to be pre-fetched by the user equipment entity, as illustrated in step 612. The list may be a list of URLs or a list of other identifiers of the web pages. In some embodiments, the list includes a list of probabilities or other pre-fetch weights associated with the retrieved web pages.

As noted above with respect to other embodiments and illustrated in FIG. 4, various different methods can be used to generate a list of web pages to be pre-fetched. However, for purposes of illustration, FIG. 6 illustrates only the use of information regarding the size of the page and information regarding whether the pages include video. It should be understood that these techniques may be integrated with other techniques described herein in the generation of a list of pages to be pre-fetched. In step 608, the network entity determines the size of at least some of the linked web pages (including the size of embedded resources such as images). The list of web pages to be pre-fetched is then based at least in part on the sizes of the linked web pages. For example, larger web pages are more likely to be excluded from the list, while smaller web pages are more likely to be included in the list. In some embodiments, the list of pages to be pre-fetched may include only pages with a size below a threshold size.

In step 610, the network entity determines whether or not the linked web pages include embedded video. The network entity may enforce a policy (which can be based on user preferences) not to pre-fetch pages with embedded video. In such an embodiment, the list of pages to be pre-fetched includes only web pages that do not include video.

In some embodiments, the list of pages to be pre-fetched is compiled by determining the probability of the user visiting the respective linked pages. In some embodiments, these probabilities may be used to determine a pre-fetch weight in a method analogous to the method illustrated in steps 508, 516, 518 of FIG. 5. The list of pages to be pre-fetched may include only those pages with a pre-fetch weight above a threshold weight. In some embodiments, the respective pre-fetch weights are included in the list of pages to be pre-fetched. In step 614, the network entity sends list of pages to be pre-fetched to the user equipment entity. The user equipment entity may pre-fetch the pages identified on the list, or the user equipment entity may apply its own policies to the list, for example by postponing any pre-fetching if the user is on the telephone, or by pre-fetching only the pages with a pre-fetch weight over the threshold weight.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method carried out by a user equipment entity, the method comprising:
retrieving a selected web page in response to a user selection of the web page, wherein the selected web page includes links to a plurality of linked web pages;
identifying at least one current user activity based at least in part on a sensor in the user equipment;
determining respective pre-fetch weights for a plurality of the linked web pages, wherein the pre-fetch weight of a linked web page is based at least in part on a size of the linked web page;
determining a threshold weight based at least in part on the identified user activity; and
pre-fetching the linked web pages having a pre-fetch weight above the threshold weight.

2. The method of claim 1, wherein the sensor is an accelerometer, and wherein identifying at least one user activity includes determining that the user is engaged in physical activity.

3. The method of claim 1, wherein the UE entity includes telephone functionality, and wherein identifying at least one user activity includes determining that the user is speaking on the telephone.

4. (canceled)

5. The method of claim 1, wherein the pre-fetch weights are based at least in part on the identified user activity.

6. The method of claim 1, wherein the pre-fetch weight of a linked web page is based at least in part on a probability of the user navigating to the linked web page.

7. (canceled)

8. The method of claim 1, wherein the pre-fetch weight of a linked web page is based at least in part on both a size of the linked web page and a probability of the user navigating to the linked web page.

9. The method of claim 1, wherein the threshold weight is based at least in part on a level of network traffic.

10. The method of claim 1, wherein identifying at least one user activity includes determining whether the user is participating in a telephone call, wherein the pre-fetching is performed only after determining that the user is not participating in a telephone call.

11. The method of claim 1, wherein identifying at least one user activity includes determining whether the user is engaged in physical activity, wherein the pre-fetching is performed only after determining that the user is not engaged in physical activity.

12. The method of claim 1, further comprising rendering at least one of the pre-fetched web pages.

13. A method carried out by at least one network entity, the method comprising:
receiving, from a user equipment entity, information identifying a web page visited by a user, wherein the visited web page includes links to a plurality of linked web pages;
retrieving a plurality of the linked web pages to determine the content of the respective linked web pages;
compiling from among the linked web pages a list of web pages to be pre-fetched, wherein the list of pages to be pre-fetched is based at least in part on the content of the respective linked web pages, wherein determining the content of the respective linked web pages includes determining a size of the respective linked web pages, wherein the list of pages to be pre-fetched is based at least in part on the sizes of the respective linked web pages; and
sending the list to the user equipment entity.

14. (canceled)

15. The method of claim 13, wherein determining the content of the respective linked web pages includes determining whether the respective linked web pages include video, wherein the list of pages to be pre-fetched includes only web pages that do not include video.

16. The method of claim 13, further comprising:
for a plurality of the linked web pages, determining a probability of the user visiting the linked web page;
wherein the list of web pages to be pre-fetched is based at least in part on the probabilities that the user will visit the respective linked web pages.

17. The method of claim 13, wherein the list of web pages to be pre-fetched includes a plurality of pre-fetch weights associated with respective linked web pages on the list.

18. A user equipment entity comprising a processor, a network interface, at least one sensor, and a non-transitory computer-readable medium, the medium storing instructions that, when executed by the processor, are operative:
to retrieve a selected web page over the network interface in response to a user selection of the web page, wherein the selected web page includes links to a plurality of linked web pages;
to identify at least one current user activity based at least in part on a sensor in the user equipment;
to determine respective pre-fetch weights for a plurality of the linked web pages, wherein the pre-fetch weight of a linked web page is based at least in part on a size of the linked web page;
to determine a threshold weight based at least in part on the identified user activity; and
to pre-fetch the linked web pages having a pre-fetch weight above the threshold weight.

19. (canceled)

20. (canceled)
